(19) United States
(12) Patent Application Publication
(10) Pub. No.: US 2013/0014148 A1
(43) Pub. Date: Jan. 10, 2013

(54) AGGREGATION-BASED METHODS FOR DETECTION AND CORRECTION OF TELEVISION VIEWERSHIP ABERRATIONS

(76) Inventors: Michael Vinson, Piedmont, CA (US); Kim Hadfield, Vancouver, WA (US); Amir Yazdani, Portland, OR (US); Aaron Harsh, Portland, OR (US); Maria Loper, Portland, OR (US)

(21) Appl. No.: 13/543,770

(22) Filed: Jul. 6, 2012

Related U.S. Application Data
(60) Provisional application No. 61/504,980, filed on Jul. 6, 2011.

(51) Int. Cl. H04N 21/258

(52) U.S. Cl. 725/14

(57) ABSTRACT

A method cleans television viewing behavior data collected from a plurality of television set top boxes by using aggregation to detect an excess or a deficit in viewership for a group of television set top boxes. In various aspects, the group of set top boxes may be associated with a particular television service provider, cable television head-end, or data warehouse. Additionally, the method can clean television viewing behavior data by detecting and correcting aberrant viewership in a time series, that is based on a weekly or an approximately monthly frequency. The aberrant viewership can be detected by calculating a minimum expected number of viewers for a day, and comparing it to the actual number of households that reported viewers for that day.

### CROSS-REFERENCE TO RELATED APPLICATION(S)

This application claims the benefit of the assignee's U.S. Provisional Patent Application No. 61/504,980, filed Jul. 6, 2011 (attorney docket number 74182.8012.US00), which is incorporated herein by reference in its entirety.

### BACKGROUND

Various problems exist for utilizing collected television set top box (“STB”) data for the analysis of television viewing behavior, such as problems related to the precision or the reliability of the data. Different collection processes and steps utilized by different television service providers may introduce different types of errors in the collected television viewing data, (e.g., data may be lost, duplicated, corrupted, etc.). Sources of television viewing data may include data collected from a group of STBs which may be transmitted to network nodes, such as regional head ends of a cable television service provider. Some nodes may, in turn, send data along to other parent nodes up a hierarchy of nodes, and the data may be processed along the way. At some point up the hierarchy of nodes, a television service provider typically collects data for its entire television viewing network.

The information collection process may differ depending on which television distribution network is utilized by the television service provider. For example, a television service provider may utilize a digital broadcast satellite system or a cable system. Third parties may then collect and combine television viewing data from multiple television service providers. The number of subscribers for a television service provider may be as high as tens of millions. Each of these different steps provides an opportunity for data corruption, accidental data duplication, or data loss, such as dropped data, known as “data drops”. Errors that occur higher up in the collection hierarchy can cause particularly severe problems with regard to the accuracy of the data.

A need exists for a system that overcomes the foregoing problems. Overall, the examples herein of prior or related systems and their associated limitations are intended to be illustrative and not exclusive. Other limitations of existing or prior systems will become apparent to those of skill in the art upon reading the following Detailed Description.

### BRIEF DESCRIPTION OF THE DRAWINGS

FIG. 1 is a block diagram illustrating a system for cleaning television viewing data by using aggregation to detect and correct aberrations of television viewership.

FIG. 2 is a flow diagram illustrating a process for cleaning television viewing data by detecting and correcting an excess or a deficit in the viewership of a television service provider for a time period.

FIG. 3 illustrates an example usage of the process of FIG. 2 to detect an excess in viewership of a television service provider.

FIG. 4 is a flow diagram illustrating a process for cleaning television viewing data by using a time series combined with a regression model to detect and correct data drops.

FIG. 5 illustrates an example usage of the process of FIG. 4 to detect a possible data drop occurring in a time series of television viewing data.

FIG. 6 illustrates an example Fourier analysis of daily television viewing data suggesting the weekly periodic time period and other intervals that can be effectively utilized by the process of FIG. 4.

### DETAILED DESCRIPTION

In an embodiment of the disclosed technology, a system cleans television viewing behavior data. The data may be collected from a plurality of television set top boxes by using aggregation to detect an excess or deficit in viewership for a group of television set top boxes. In various aspects, the group of set top boxes may be associated with a particular television service provider, cable television head-end, or data warehouse.

Additionally or alternately, the system can clean television viewing behavior data by detecting and correcting aberrant viewership in a time series. The aberrant viewership can be detected by calculating a minimum expected number of viewers for a day, and comparing it to the actual number of households that reported viewers for that day. If the actual number of viewers on that day is below the minimum expected number of viewers, an aberration is detected. The minimum expected number of viewers is calculated by using a linear regression model and applying the threshold. The linear regression model is calculated from historic viewing data, which may be weighted or filtered according to a periodically recurring time period (e.g., a periodic one week long recurring period). The detection process may be repeated for other days in a time period.

In some embodiments of the disclosed technology, the system may store the cleaned television viewing behavior data in a non-transitory computer readable storage medium. The computer readable storage medium may then be distributed to a third-party, who may use it for analyzing television viewing behavior with a high degree of accuracy and reliability. In some embodiments, all or part of the system is implemented by computer-executable instructions that are stored in a non-transitory computer readable storage medium.

Various embodiments of the invention will now be described with reference to the figures. The following description provides specific details for a thorough understanding and enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments.

The terminology used in the description presented herein is intended to be interpreted in its broadest reasonable manner, even though it is being used in conjunction with a detailed description of certain specific embodiments of the invention. Certain terms may even be emphasized herein; however, any terminology intended to be interpreted in any restricted manner will be overtly and specifically defined as such in this Detailed Description section.

### Suitable System

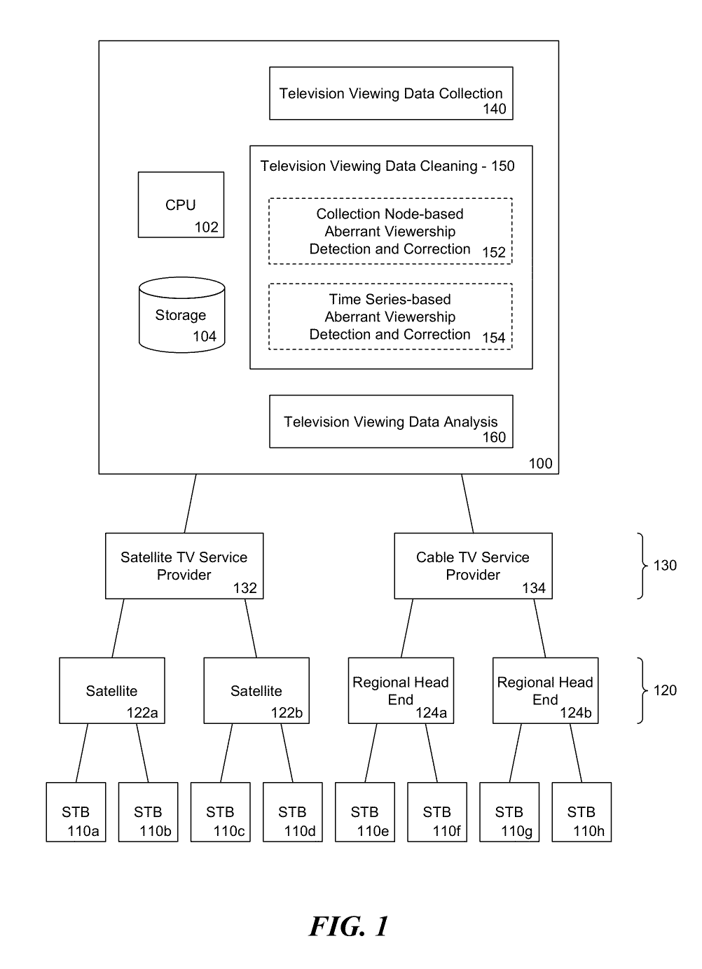

FIG. 1 is a block diagram illustrating a system 100 for cleaning television viewing data by using aggregation to detect and correct aberrations of television viewership. The system 100 utilizes a central processing unit (CPU) 102 that executes instructions implementing at least some components of the system, and a storage device 104 that stores the instructions. The components include a television viewing data collection component 140, a television viewing data cleaning component 150, and a television viewing data analysis component 160. The components 140, 150, and 160 may be in the form of software (such as functions, objects, subroutines, and applications), and/or hardware (such as embedded instructions). Some embodiments of the system may utilize multiple processors and/or storage devices. For the sake of brevity, FIG. 1 illustrates a single CPU 102, and a single storage device 104.

The television viewing data collection component 140 collects television viewing behavior data that represents the viewing behavior of many television viewers (also known as a viewing audience). The viewing behavior data is typically buffered in television set top boxes (STBs) 110a-110h, which decode video signals for television sets. In some embodiments, an STB 110 will be physically housed in a television set, while in others an STB 110 will be physically separated from the television set. An STB 110 that is physically separated will typically send decoded audio and video signals to a television set in the form of one or more cables such as a coaxial cable carrying an analog signal, a High Definition Multimedia Interface cable carrying a digital signal, and so on.

The STBs 110a-110h typically receive their video signals from television network distribution nodes 120, including nodes representing television service providers 130. In the case of a satellite television service provider 132, the STBs 110a-110d receive video signals from the satellite television service provider's 132 satellites 122a and 122b. The satellite television service provider 132 may also be known as a direct broadcast satellite (DBS) service provider. Examples of DBS service providers include: DirecTV Group Inc. of El Segundo, Calif.; and Dish Network Corporation of Englewood, Co.

In the case of a cable television service provider 134, the STBs 110e-110h receive video signals from the cable television service provider's 134 regional head ends 124a and 124b. A cable television service provider 134 with multiple regional head ends 124a and 124b is also known as a multiple system operator (MSO). Examples of MSO's include: Comcast Corporation of Philadelphia, Pa.; Time Warner Cable Inc. of New York, N.Y.; and Cox Communications of Atlanta, Ga.

Although not illustrated in FIG. 1 for the sake of brevity, a television signal may be distributed through a deep hierarchy of nodes on its way to reaching an STB 110. For example, a cable television signal may pass from a regional head-end 124 through a fiber optic trunk line, a series of distribution amplifiers, pole-mounted fiber-optic nodes, and a coaxial line in its way to reaching one of the STBs 110e-110h.

In many cases, some of which are shown in FIG. 1, an STB 100 will periodically send its viewing data back through the same network that it used to receive its television viewing signals. In other cases, an STB can send its viewing data back through a different network to be collected by, for example, a television service provider 130 or a data warehouse, on its way to the system 100. For example, an STB that receives television viewing data from a television “receive only” satellite might send its viewing data to the satellite TV service provider 132 using alternate data collection nodes that the STB is connected to. Examples of alternate data collection nodes include: nodes on the Internet, nodes on a wireless terrestrial network, nodes on a public-switched telephone network, nodes on a power line communication system, etc.

Although an STB 110 will typically be located on a customer's premises, it may or may not be customer-owned. In many cases, an STB 110 will be owned by a television service provider 130, and leased to the customer. However, in some cases, a customer may purchase, own, and use an STB that the television service provider supports. Moreover, new STB models are frequently introduced with new features demanded by the marketplace (such as Digital Video Recording, additional tuners, etc.). Accordingly, some television service providers 130 may support a wide variety of different manufacturers, models, and versions of STBs 110.

Some additional details regarding the system 100, including the manner in which it may collect and use television viewing data can be found in U.S. patent application Ser. No. 11/701,959, filed on Feb. 1, 2007, entitled “Systems and Methods for Measuring, Targeting, Verifying, and Reporting Advertising Impressions”; U.S. patent application Ser. No. 13/081,437, filed on Apr. 6, 2011, entitled “Method and System for Detecting Non-Powered Video Playback Devices”; and U.S. patent application Ser. No. 13/096,964, filed on Apr. 28, 2011, entitled “Method and System for Program Presentation Analysis”; each of which is herein incorporated by reference in its entirety. In addition, other problems associated with collected television set top box data, which may additionally be detected and corrected by the data cleaning module 150, are described in an application entitled “SYSTEM AND METHOD FOR CLEANING TELEVISION VIEWING MEASUREMENT DATA” (attorney docket no. 741828012US01), filed concurrently herewith and hereby incorporated by reference in its entirety.

### Collection Node-Based Aberrant Viewership

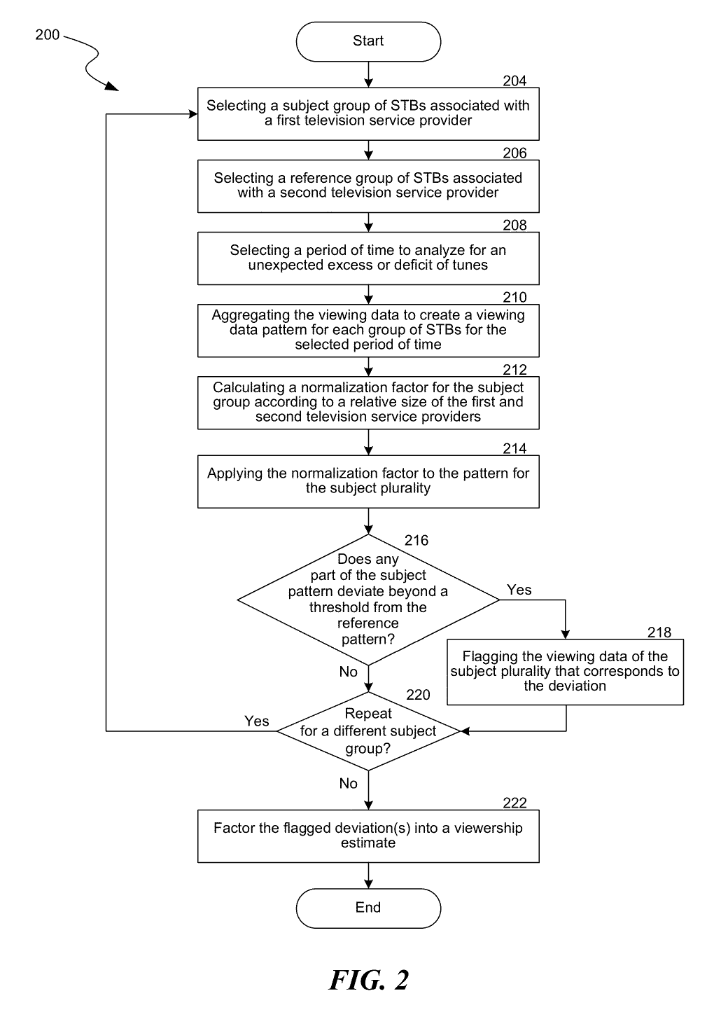

FIG. 2 is a flow diagram illustrating a process 200 for cleaning television viewing data, such as may be performed by the system 100. As shown in FIG. 2, at a block 204, the process selects a “subject” group or plurality of STBs that is associated with a first television service provider. For example, if the first television service provider is the provider 132, then the STBs 110a-110d, which are configured to receive video content from the provider 132 may be selected as the subject group. The selection may be determined based on which STBs are maintained by the first television service provider, or which STBs are configured to send television viewing data to the first television service provider. Usually these will be equivalent, but not always.

At a block 206, the process selects a “reference” plurality or group of STBs that is associated with a second television service provider. For example, if the cable TV service provider 134 is the second television service provider, then the STBs 110e-110h configured to receive video content from the provider 134 may be selected as the reference group. In order for the process to be useful, the reference group of STBs needs to be selected so that it differs from the subject group of STBs.

At a block 208, the process selects a period of time to analyze for an unexpected excess or deficit (i.e., an aberration) of television viewership in the subject group of STBs. In some embodiments, the process may automatically select the time period based on newly received television viewing data that has not yet been processed.

At a block 210, the process aggregates the viewing data for the subject group of STBs for the selected period of time to create a “subject” pattern of viewing data. Also, at the block 210, the process aggregates the viewing data for the reference group of STBs for the selected period of time to create a “reference” pattern of viewing data. The aggregated data may simply be a count of the number of set top boxes, households, or other viewing units that reported viewing data for various time subperiods within the selected period of time. For example, if the selected period of time is a specific day, and if the subperiods are each 15 minutes long, then each of the subject and reference patterns will contain 96 subperiods.

At a block 212, the process calculates a normalization factor for the subject group of STBs according to the size of the first second television service provider in relation to the size of the second television service provider. For example, if the first television service provider has a customer footprint of 1 million set top boxes, and the second television service provider has a customer footprint of 600,000 set top boxes, then the normalization factor may be determined as follows: 600,000/1,000,000÷=0.6.

At a block 214, the process applies the calculated normalization factor to the viewing data patterns, so that they can be compared. For example, the subject pattern may be multiplied by the normalization factor to adjust it to be directly comparable to the reference pattern.

At a decision block 216, the process makes a determination as to whether any portion of the subject pattern deviates from the reference pattern beyond a threshold. The threshold may be predetermined, and may be a fixed percentage of viewers (e.g., 5%), a fixed number of viewers (e.g., 1,000), or some combination of both (e.g., 5%+1000). This determination may be performed repeatedly for each time subperiod contained within the patterns. If a determination is made that no portion of the subject patterns deviates from the reference pattern, processing continues to a decision block 220, as will be described in more detail below. If a determination is made that some portion (e.g., at least one subperiod) of the subject pattern deviates from the reference pattern, processing continues to a block 218. At the block 218, the process flags the viewing data of the subject group of STBs that corresponds to the deviation.

In the decision block 220, the process decides whether to repeat the detection process again from the block 204 for a different subject group. In some embodiments, the detection process may be repeated separately for each television service provider. If the process is to be repeated, some or all of the steps 204-220 may be repeated. If the detection process is not to be repeated, then the process proceeds to a block 222. At the block 222, one or more flagged deviations are factored into a viewership estimate or otherwise corrected.

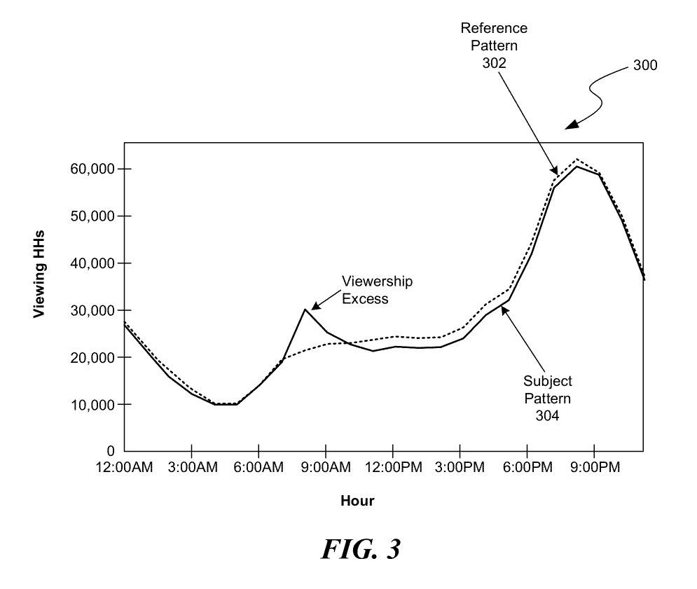

FIG. 3 illustrates an example usage of the process of FIG. 2. In the specific example of FIG. 3, the process is used to detect an excess in the viewership of a television service provider occurring around 8:00 AM, within a day-long period that is being analyzed. As shown in FIG. 3, information 300 pertains to a particular day, e.g., Jun. 4, 2011. A reference pattern 302 and a subject pattern 304 range from between approximately 10,000 to 60,000 viewing households. One or both of these patterns 302 and 304 have been normalized (such as in the block 214), so that they can be directly compared for aberrations. In the approximately 1-hour long subperiod around 8:00 a.m., a viewership excess may be detected in the subject pattern 304. At this time, the subject pattern 304 represents approximately 30,000 viewers, while the reference pattern 302 represents approximately 21,000 viewers. Therefore, an excess of viewership in the subject group of STBs ranging as high as approximately 9,000 viewers may be detected and corrected during this subperiod.

In some embodiments, the viewership excess may be determined by taking the actual difference and subtracting the maximum difference allowable from the reference pattern according to the threshold. For example, for the illustrated patterns indicated in FIG. 3, if the threshold allowed a deviation of 5,000 viewers (or 23.8%), the excess of viewership may be determined to be 9,000−5,000=4,000. When the subject pattern 304 was normalized by a correction factor (e.g., dividing by the correction factor), the excess (or deficit) of viewership should have the normalization process reversed (e.g., multiplying the excess by the correction factor), to determine the actual correction.

### Time Series-Based Aberrant Viewership

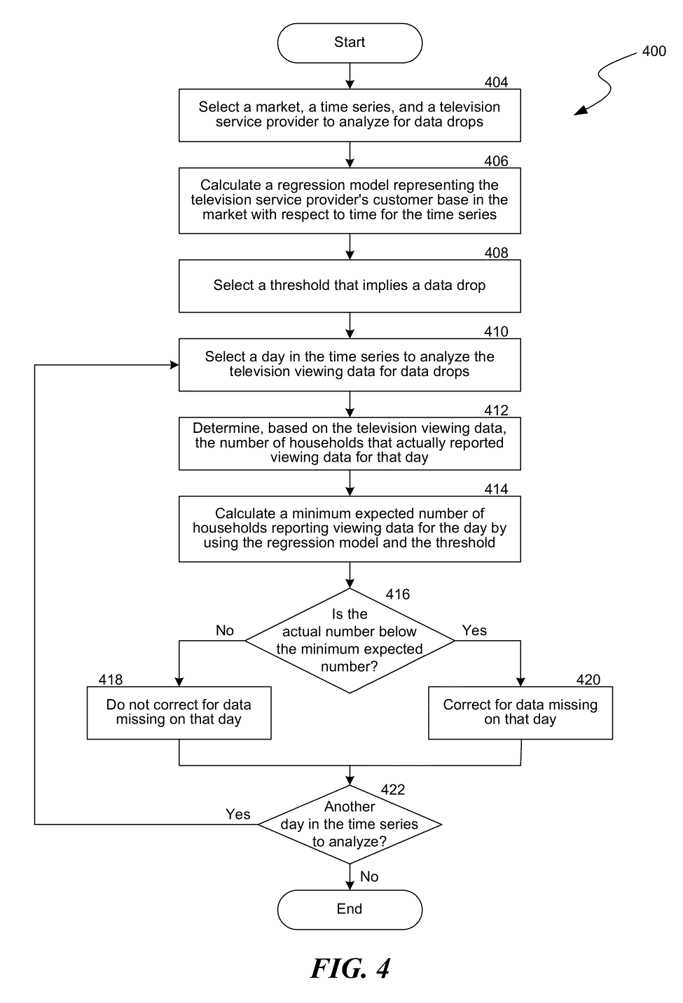

FIG. 4 is a flow diagram illustrating a process 400 for cleaning television viewing data by using a time series combined with a regression model to detect and correct data drops. The process 400 may be performed by the system 100. As shown in FIG. 4, at a block 404, the process selects a market, a time series, and a television service provider to analyze for data drops. For example, the process may select a “Pacific Time Zone” market, a “Tuesday” time series, and the particular cable TV service provider 134. (In other examples, a time series may be selected based on some other day of the week.)

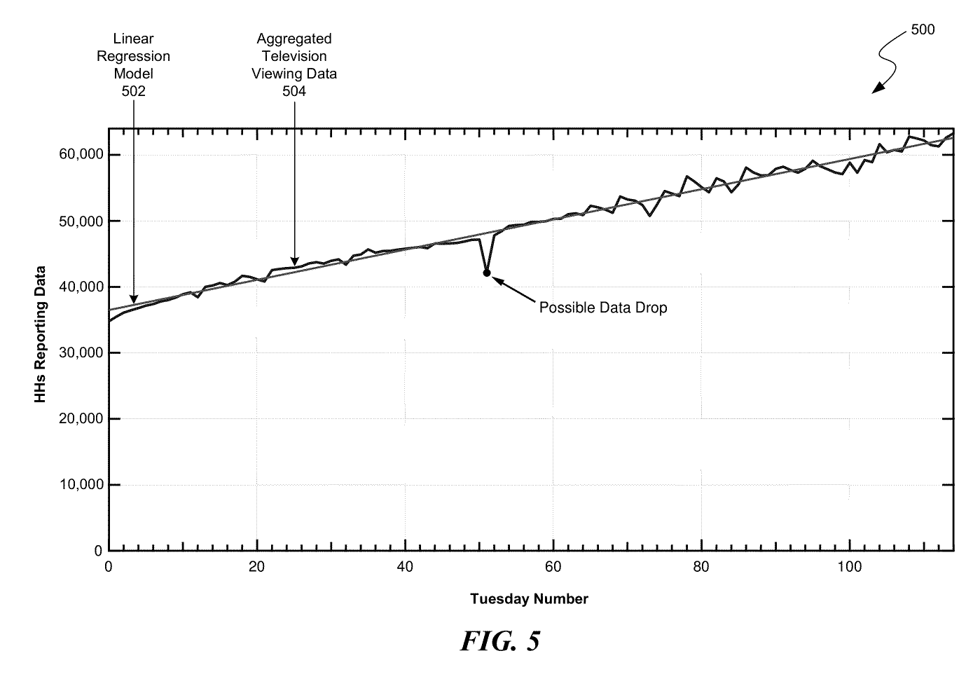

At a block 406, the process calculates a regression model representing the selected television service provider's customer base with respect to time for at least the selected time series. The calculated regression model may be linear, as will be described in more detail below with respect to FIG. 5.

At a block 408, the process selects a viewership threshold indicative of a data drop. In various embodiments, similar to the threshold selected in block 216, the threshold in block 406 may be predetermined, and may be a fixed percentage of viewers (e.g., 5%), a fixed number of viewers (e.g., 1,000), or some combination of both (e.g., 5%+1000).

At a block 410, a day in the time series is selected to analyze the television viewing data for data drops. In some embodiments, a range of days for which processing is desired is accessed, and the first day in the range falling within the time series that has not yet been processed will automatically be selected.

At a block 412, the process determines, based on the television viewing data, the number of households that actually reported viewing data for the selected day. This may be performed by aggregating the collected viewing data for the selected day, while counting any household (or other viewing unit, such as a STB) that reported any sort of viewing data for that day.

At a block 414, the process calculates a minimum expected number of households reporting viewing data for the selected day. This calculation uses the regression model that was calculated at the block 406, as well as the threshold selected at the block 408.

At a decision block 416, the process determines whether the actual number of viewers is below the minimum expected number. If it is not below, then processing continues to a block 418, where the system does not correct for data missing on that day. If it is below, then processing continues to a block 420, where the system corrects for data missing on that day.

After block 418 or 420, processing continues to a decision block 422, where a determination is made whether to analyze another day in the time series. If another day is to be analyzed, then the processing returns to the block 410. If there are no more days to be analyzed, then the processing ends.

FIG. 5 illustrates an example usage of the process of FIG. 4 to detect a possible data drop occurring in a time series 504 of television viewing data, shown plotted against a linear regression model 502. In this example, the regression model 502 and the time series 504 of aggregated television viewing data represent aggregated daily television viewing data for 114 different Tuesdays. In other words, the model 502 and the time series 504 span an approximate 2.2 year time period, and exclude Mondays, Wednesdays, Thursdays, Fridays, Saturdays, and Sundays. In this example, the possible data drop occurring on the 51st Tuesday of the time series 504 is detectable by using the process 400.

In this example, where the 51st Tuesday is in series 504, the process 400 uses the linear regression model 502 to calculate the number of households expected to report television viewing data on that day, which is approximately 47,500 viewers. If the selected threshold that implies a data drop allows a maximum deviation of 2500 viewers (or approximately 5%), then the calculated minimum expected number of households reporting viewing data for the selected day is: 47,500−2500=45,000 viewers.

In some embodiments, the correction performed in the block 420 may consist of analyzing a predetermined number (e.g., 5) of days in the time series that immediately precede and/or follow the day for which the error was detected, ignoring the lowest and the highest of the calculated viewership numbers for those days, and averaging the calculated viewership numbers of the remainder to determine what viewership number is desirable to correct. For example, referring to FIG. 5, if the 51st Tuesday is determined to be a possible data drop, a corrected viewership number could be obtained by taking the numbers of households reporting viewing data for the 45th, 46th, 47th, 48th, 49th, and the 50th Tuesdays, ignoring the lowest and the highest of them, and averaging the remainder. By ignoring the lowest and highest of the group, it would eliminate nearby statistical outliers in terms of viewing data, such as the Superbowl, from influencing the correction operation. In various embodiments, the correction performed in the block 420 may additionally or alternately consist of utilizing the value of the linear regression model 502 for that day.

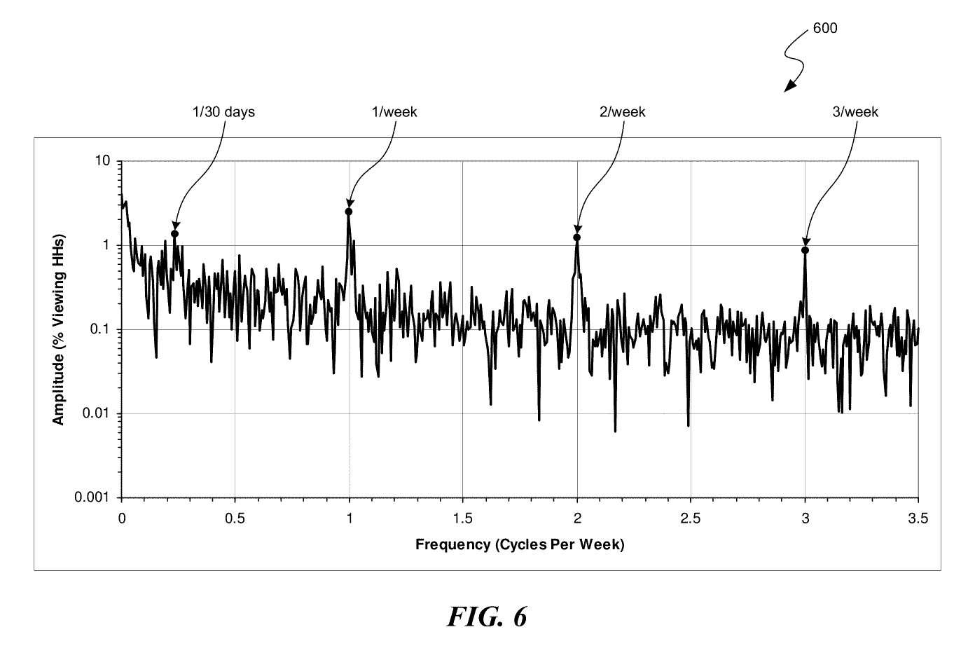

FIG. 6 illustrates an example Fourier analysis 600 of daily television viewing data suggesting the weekly periodic time period as well as at least one other interval that can be effectively utilized by the process 400 of FIG. 4. Here, a strong amplitude in the percentage of households reporting television viewing data is noticeable at the once per week frequency, as well as the intraweek harmonics of twice per week, and three times per week. Additionally, a lesser amplitude peak is apparent at the frequency occurring every 30 days. Therefore, in alternate embodiments, the process 400 may be altered so that the selected time series, instead of on being based on a weekly frequency, is based on a 30 day frequency (or alternately, on a 31 day or a monthly frequency, or even a quarterly frequency.)

### Alternate Embodiments

In some embodiments, the process 200 in block 206 automatically and arbitrarily selects a second television service provider that is different from the first television service provider. In other embodiments, the process 200 in block 206 selects the reference group of STBs associated with at least a second television service provider, such as all television service providers for which viewing data is available.

In some embodiments, when processing power and/or storage space allows, the subject and reference data patterns that the process 200 creates in the block 210 may be continuous—i.e., they may have no significantly long subperiod and effectively represent “real time” viewing activity throughout the selected period. In other embodiments, other subperiods, such as one-hour long subperiods, or specific time windows that occur within each day (“dayparts”), and so on, may be utilized. As another example, a seven day long period may be selected for analysis in the block 208, and each subperiod of viewing data stored in the pattern may be one day. In another example, the subperiod may be equal to the period (i.e., each pattern may have only one number of viewers in it.)

In alternate embodiments, the process 200 may individually normalize both the subject pattern and the reference pattern to a particular, normalized size. (For example, to normalize the patterns so that they are representative of a single viewer, or alternately, 10,000 viewers, etc.) The normalized size may be predetermined. In yet another alternate embodiment, the process 200, in the blocks 212 and 214, may normalize the reference pattern to make it comparable to the subject pattern, rather than vice versa.

In alternate embodiments, instead of the process 200 selecting the subject and reference pluralities of STBs corresponding to a first and second television service provider in the blocks 204 and 206, the process 200 may select the pluralities according to which other collection node was utilized. For example, which regional head end (e.g. the head end 124a, or the head end 124b), which satellite (e.g., the satellite 122a, or the satellite 122b), or which data warehouse may determine the selected subject and reference pluralities of STBs, rather than the associated television service provider.

In some embodiments, the correction of aberrant viewership in the process 200 may be performed directly on the viewing data as soon as the aberration is detected, in addition or alternately to the aberration being flagged. Likewise, the correction of aberrant viewership in the process 400 may be flagged for correction later on, rather than being corrected as shown in the block 420.

In some embodiments, the process 400 may calculates in 406 a regression model that is nonlinear. For example, the regression model may be a sigmoid function that is “S-shaped”, or a polynomial function, and so on.

In alternate embodiments, the process 400 may select the time series in the block 404 containing more than one of the days of the week. For example, Saturdays combined with Sundays may form the basis of a selected time series excluding Mondays through Fridays. Other combinations of days of the week, such as Mondays, Tuesdays, Wednesdays, Thursdays, and Fridays, or Mondays, Wednesdays, and Fridays, are also possible.

Although not shown for the sake of brevity in FIG. 4, various steps may also be repeated. For example, repeating to the block 404 may occur, in order to select another market, another time series, or another television service provider to analyze for data drops. In some embodiments, different time series will be selected until all desired days to analyze for data drops are processed. For example, after processing Mondays, Tuesdays could be processed, and after processing Tuesdays, Wednesdays could be processed, and so on, until all days of the week are processed when desired.

In some embodiments, the regression model that is calculated in the block 406, or other potentially processor-intensive tasks may be saved, e.g., in the storage device 104, for repeatedly reuse without requiring that they be recalculated. Similarly, the system 100 may save other selections, aggregations, calculations, and determinations performed by the television viewing data cleaning component 150, so that, for example, subsequently collected television viewing data can be rapidly cleaned, in preparation for analysis by the television viewing data analysis component 160.

In some embodiments, one or more selections performed in the processes 200 and 400 may be manually specified by a user of the system 100. For example, the user may specify parameters in a configuration file or graphical user interface drop down menu, or text box. The manually specified parameters may include, for example, which television service providers, which data collection or television distribution nodes, which pluralities of set top boxes, which periods of time, which normalization factors (or which size measurements to be used for calculating normalization factors), which markets, which time series, which regression model types, which thresholds implying a data drop, and which other configuration parameters the system 100 should use for detecting and correcting aberrant television viewership or performing other television viewing data cleaning or analysis.

In some embodiments, thresholds, such the threshold used in the block 216 and the threshold selected in the block 408 are determined to provide a specific likelihood or margin of error, such as an error detection rate of approximately 2%, or to detect statistical outliers, e.g., those that depart from the mean of a normal distribution by approximately 2-3 standard deviations.

In some embodiments, humans will be involved in the process before a detected error is corrected. For example, a human operator could review the detected error for verification, prior to allowing the system to perform any correction. In some embodiments, different error correction steps may be performed than those disclosed in FIGS. 2 and 4. For example, some or all data associated with the errors may be ignored or discarded.

In some embodiments, additional steps for cleaning television viewing data may be performed by the system 100. For example, other cleaning techniques or methods for filtering television viewing data could be performed by the system 100 in addition to the cleaning processes 200 and 400. For example, television off detection could be implemented by the system 100 and performed before the processes 200 and 400. These cleaning, filtering, and processing steps may be performed in series or even in some cases, in parallel. For example, all data for which errors are detected by multiple processes running in parallel could be flagged by those processes, and when all processes are done running, the correction of any flagged problems would be performed at the end—perhaps after being reviewed and guided by a human user.

Although not required, aspects and embodiments of the invention utilize the general context of computer-executable instructions, such as routines executed by a general-purpose computer, e.g., a server or personal computer. Those skilled in the relevant art will appreciate that the invention can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like. The invention can be embodied in a special purpose computer or data processor that is specifically programmed, configured or constructed to perform one or more of the computer-executable instructions explained in detail herein. Indeed, the term “computer”, as used generally herein, refers to any of the above devices, as well as any data processor or any device capable of communicating with a network, including consumer electronic goods such as game devices, cameras, or other electronic devices having a processor and other components, e.g., network communication circuitry.

The invention can also be practiced in distributed computing environments, where tasks or modules are performed by remote processing devices, which are linked through a communications network, such as a Local Area Network (“LAN”), Wide Area Network (“WAN”) or the Internet. In a distributed computing environment, program modules or sub-routines may be located in both local and remote memory storage devices.

In general, the detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

These and other changes can be made to the invention in light of the above Detailed Description. While the above description details certain embodiments of the invention and describes the best mode contemplated, no matter how detailed the above appears in text, the invention can be practiced in many ways. Details of the invention may vary considerably in its implementation details, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

We claim:

1. A processor-based method for cleaning television viewing data by detecting and correcting a viewership aberration, the method comprising:
selecting a period of time to analyze;
selecting a subject plurality of set top boxes corresponding to a first television service provider;
selecting a reference plurality of set top boxes corresponding to at least a second television service provider;
aggregating the viewing data across the subject plurality of set top boxes to create a subject viewing data pattern for the selected period of time;
aggregating the viewing data across the reference plurality of set top boxes to create a reference viewing data pattern for the selected period of time;
calculating a normalization factor according to at least the relationship of a size associated with the first television service provider compared to a size associated with the second television service provider;
applying the normalization factor to the viewing data patterns to make them comparable when the television service providers have different customer footprints;
determining, by a processor, if any part of the subject viewing data pattern deviates beyond a threshold from the reference viewing data pattern; and
if a deviation was determined, flagging the deviation for factoring into the calculation of a corrected viewership estimate.
